(19) United States
(12) Patent Application Publication
(10) Pub. No.: US 2022/0158266 A1
(43) Pub. Date: May 19, 2022

(54) NESTED STRUCTURE LITHIUM ION BATTERY CAPABLE OF REDUCING RISK OF THERMAL RUNAWAY

(71) Applicant: Nanjing Tech University, Nanjing City (CN)

(72) Inventors: Zhirong WANG, Nanjing City (CN); Jinlong BAI, Nanjing City (CN)

(21) Appl. No.: 17/524,290

(22) Filed: Nov. 11, 2021

(30) Foreign Application Priority Data
Nov. 14, 2020 (CN) 2020112738801

(51) Int. Cl. H01M 10/613; H01M 10/0525; H01M 10/04

(52) U.S. Cl. CPC H01M 10/613; H01M 10/0422; H01M 10/0525

(57) ABSTRACT

A nested structure lithium ion battery capable of reducing a risk of thermal runaway includes a metal housing and a battery cell filled in the housing. The housing includes an inner cylinder and an outer cylinder. The inner cylinder is located in a through hole in the center of the outer cylinder, and there is a gap between a side wall of the inner cylinder and a secondary outer wall of the outer cylinder. The battery cell includes an outer battery cell and an inner battery cell. The outer battery cell is filled in a cavity of the outer cylinder, and the inner battery cell is filled in a cavity of the inner cylinder. This nested structure lithium ion battery divides the battery cell into two parts. The gap is used as a heat dissipation channel in a high temperature environment.

### TECHNICAL FIELD

The present invention belongs to the technical field of lithium ion batteries, and specifically relates to a nested structure lithium ion battery capable of reducing a risk of thermal runaway.

### BACKGROUND ART

The lithium ion battery tends to accumulate heat during charging-discharging and using processes due to own properties thereof, this heat may cause the increase of the temperature of the battery during working, so that the working performance and safety of the battery are reduced, especially while the lithium ion battery is used as a power source of an electric vehicle, because of the dense stacking of the batteries and the difficulty of heat conduction, it is easier to cause the continuous increase of the temperature inside a battery pack and the uneven temperature, the continuous increase of the temperature may cause the decrease of the stability of the battery, so that the thermal runaway occurs in the battery, and a series of safety accidents is caused.

The poor performance of the lithium ion battery at a low temperature is also a main reason for the existing greatly reduced battery life of the electric vehicle in winter, the lithium ion battery is an ideal battery that serves as a power storage unit for a pure electric vehicle, but both the high temperature and low temperature performances thereof are very poor, and an ambient temperature window required for the optimal performance is smaller, this restricts the development of the electric vehicle to a certain extent. However, if the battery is operated at the low temperature for a long time, it may cause lithium precipitation at a negative electrode inside the battery, so that the stability and safety of the battery are reduced after the temperature rises, a lithium precipitation degree may be increased with the prolonged working time of the battery at the low temperature, so that the risk of thermal runaway of the battery is increased.

The main reason that affects the high temperature performance of the battery is that if the energy density of the battery pack of the electric vehicle is to be increased, the volume of a battery cell must be larger and larger, as to reduce the proportion of a useless space, but the battery cell is larger, a distance between a center of the battery and a surface of the battery is farther, a problem of heat accumulation during charging-discharging and working of the battery is more serious, and the temperature unevenness inside the battery is higher, this may cause the poor performance and the reduced safety after the battery is charged and discharged for several times, so that the thickness of the battery in the battery pack of the existing electric vehicle is limited.

At present, the heating requirement of the battery at the low temperature may result in a heating device inside the battery pack necessarily, as to guarantee that the battery may be heated to a suitable working temperature at the low temperature, in order to save a system of a cooling system and a heating system, a thermal management system of each automobile manufacturer contains functions of these two parts at the same time, but the heating device itself still occupies the internal volume of the battery pack, and because of the many functions to be realized, the integration and complexity of the thermal management system are very high, this makes the technology threshold and the processing requirements are very high, so the development of the lithium ion battery pack is hindered.

### SUMMARY OF THE INVENTION

A purpose of the present invention is to provide a nested structure lithium ion battery capable of reducing a risk of thermal runaway, as to solve technical problems in the prior art that the lithium ion battery has the uneven internal temperature of the battery and the difficulty in dissipating heat or heating because of the complicated thermal management.

In order to achieve the above purpose, a specific technical scheme adopted by the present invention is as follows:

A nested structure lithium ion battery capable of reducing a risk of thermal runaway, including a metal housing and a battery cell filled in the housing;

the housing includes an inner cylinder and an outer cylinder, both of which are a cylindrical structure with a bottom and without a cover, herein the outer cylinder includes an outer wall and a secondary outer wall, an end face of the outer cylinder is ring-shaped, the inner cylinder is located in a through hole in the center of the outer cylinder, there is a gap between a side wall of the inner cylinder and the secondary outer wall of the outer cylinder, and a metal connecting rib is arranged in the gap to fixedly connect the inner cylinder and the outer cylinder as a whole and conduct;

the battery cell includes an outer battery cell and an inner battery cell, the outer battery cell is filled in a cavity of the outer cylinder, and the inner battery cell is filled in a cavity of the inner cylinder; a lower end of the inner battery cell is connected with a bottom plate of the inner cylinder through an inner battery cell lower pole piece to conduct; an upper end opening of the outer cylinder is provided with a first battery protection assembly, and an upper end of the outer battery cell is connected with an outer battery cell electrode cap arranged on an upper surface of the first battery protection assembly through an outer battery cell upper pole piece to conduct; a lower end of the inner battery cell is connected with a bottom plate of the inner cylinder through an inner battery cell lower pole piece to conduct; and an upper end opening of the inner cylinder is provided with a second battery protection assembly, and an upper end of the inner battery cell is connected with an inner battery cell electrode cap arranged on an upper surface of the second battery protection assembly through an inner battery cell upper pole piece to conduct.

In the present application, by designing the housing of the lithium ion battery as an inner and outer nested structure, there is a gap between the inner cylinder and the outer cylinder, but the two are connected by the connecting rib, and they are still essentially a whole. The outer battery cell and the inner battery cell are conducted through the metal housing. By changing the connection type of the positive and negative pole pieces of the outer battery cell and the inner battery cell with the housing, the two battery cells may achieve the series connection or parallel connection.

This inner and outer nested structure may further increase the geometric size of a single lithium ion battery under a precondition without increasing the winding thickness of the battery cell, thereby the overall energy density of the battery pack is increased. Although the interior of this nested lithium ion battery is divided into two battery cells, the outer battery cell and the inner battery cell are connected through the housing to conduct, without the need for other external assemblies to connect. This structure is convenient for the connection of the outer battery cell and the inner battery cell on the one hand, and makes the working state of the outer battery cell and the inner battery cell in a separable and combinable state on the other hand, so options while the battery pack is assembled are increased.

The battery cell of the lithium ion battery related in the present invention is an ordinary winding battery cell, and the structure of the battery protection assembly is similar to the structure of a safety protection device of an ordinary cylindrical lithium ion battery, except that the structure and shape of the lithium ion battery are changed according to the need for the nested battery related in the present invention. Herein, the first battery protection assembly is a safety assembly such as a ring-shaped insulating cover plate and an internal safety valve, the outer battery cell electrode cap and the housing are separated, as to prevent the two from being conducted. The second battery protection assembly is a safety assembly such as an insulating cover plate and an internal safety valve, the inner battery cell electrode cap and the housing are separated, as to prevent the two from being conducted.

This nested structure lithium ion battery divides the battery cell into two parts, which may make the outer battery cell or the inner battery cell work intermittently during use, or enable one of the battery cells after the other is used. While used in a high temperature environment, the outer battery cell or the inner battery cell works intermittently, so that one of the battery cells serves as a cold source while the other battery cell works, and the gap between the inner cylinder and the outer cylinder serves as a heat dissipation channel, which may quickly dissipate heat and prevent an accident caused by overheating; and while used in a low temperature environment, the inner battery cell works firstly, and the heat generated while the inner battery cell works heats the outer battery cell, and after the overall temperature rises to a normal working state, the outer battery cell or the inner battery cell is enabled at the same time, so that the outer battery cell with higher energy may work in an optimal performance temperature area, and the temperature of the battery may be adjusted in a variety of ways.

Further preferably, the inner cylinder, the outer cylinder and the connecting rib are integrally formed, the structural stability is good.

Further preferably, the outer cylinder is a cylindrical or cubic housing.

Further preferably, the electrodes of the outer battery cell upper pole piece and the inner battery cell upper pole piece are the same, and the outer battery cell and the inner battery cell are connected in parallel through the housing.

Further preferably, after the outer battery cell and the inner battery cell are connected to a circuit in parallel through the housing, there are three working states as follows:

1) while two wiring terminals in the circuit are respectively connected with the housing and the inner battery cell electrode cap to conduct, the inner battery cell is in the working state, and the outer battery cell does not work;

2) while the two wiring terminals in the circuit are respectively connected with the housing and the outer battery cell electrode cap to conduct, the outer battery cell is in the working state, and the inner battery cell does not work; and

3) while one wiring terminal in the circuit is connected with the inner battery cell electrode cap and the outer battery cell electrode cap to conduct at the same time, and the other wiring terminal is connected with the battery housing to conduct, the outer battery cell and the inner battery cell work simultaneously after being connected in parallel.

Further preferably, the electrodes of the outer battery cell upper pole piece and the inner battery cell upper pole piece are different, and the outer battery cell and the inner battery cell are connected in series through the housing.

Further preferably, after the outer battery cell and the inner battery cell are connected to a circuit in series through the housing, there are three working states as follows:

1) while two wiring terminals in the circuit are respectively connected with the housing and the inner battery cell electrode cap to conduct, the inner battery cell is in the working state, and the outer battery cell does not work;

2) while the two wiring terminals in the circuit are respectively connected with the housing and the outer battery cell electrode cap to conduct, the outer battery cell is in the working state, and the inner battery cell does not work; and

3) while the two wiring terminals in the circuit are respectively connected with the inner battery cell electrode cap and the outer battery cell electrode cap to conduct, the outer battery cell and the inner battery cell work simultaneously after being connected in series.

Further preferably, the gap between the side wall of the inner cylinder and the secondary outer wall of the outer cylinder is filled with a heat conduction material. While used in the low temperature environment, the inner battery cell works firstly, and the heat generated while the inner battery cell works heats the outer battery cell, and after the overall temperature rises to the normal working state, the outer battery cell or the inner battery cell is enabled at the same time, so that the outer battery cell with higher energy may work in the optimal performance temperature area, and the temperature of the battery may be adjusted in a variety of ways.

Compared with the prior art, the beneficial effects of the present invention are as follows:

1. In the present invention, the lithium ion battery cell is divided into two parts, the outer battery cell and the inner battery cell, and the gap is reserved between the two. The heat generated while the battery cell works may escape through the gap, and in the case that the diameter of the lithium ion battery is increased, the overall thickness of the battery cell remains unchanged or thickening is not apparent, so a disadvantage that the heat at the center is difficult to dissipate while the battery works is improved.

2. In this application, because there are three wiring areas for the lithium ion battery, there is a plurality of choices for the working state of the battery cell, and by changing the connection type of the positive and negative electrodes of the battery cell with the battery housing and the electrode cap, the series-parallel connection between the outer battery cell and the inner battery cell is achieved; in addition, the separated outer battery cell and inner battery cell may work intermittently, so that the heat generation of the battery only occurs in one of them, and the other may be used for partial heat dissipation; and in the low temperature environment, the inner battery cell works firstly, and the heat generated heats the outer battery cell, the heating efficiency is higher, the heating is more uniform, and an additional heating device is not needed.

3. Since the battery is divided into two battery cells, and there is the gap between the two parts, after the battery is subjected to an external mechanical acting force, there is a crumple space inside the battery, which may offset the external mechanical damage through deformation, and protect the safety of the overall battery pack.

### BRIEF DESCRIPTION OF THE DRAWINGS

FIG. 1 is a top view of a nested structure lithium ion battery in Embodiment I of the present invention.

FIG. 2 is an A-A cross-sectional view of FIG. 1.

FIG. 3 is a top view of a nested structure lithium ion battery with a cylindrical outer cylinder of the present invention.

FIG. 4 is a top view of a nested structure lithium ion battery in Embodiment II of the present invention.

FIG. 5 is a B-B cross-sectional view of FIG. 4.

### DETAILED DESCRIPTION OF THE INVENTION

Technical schemes in embodiments of the present invention are clearly and completely described below in combination with drawings in the embodiments of the present invention.

### Embodiment I

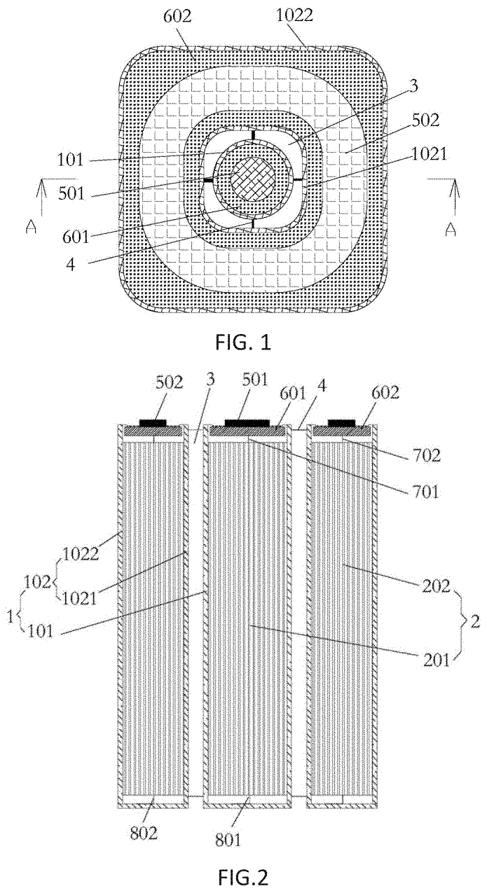

As shown in FIGS. 1 and 2, a nested structure lithium ion battery capable of reducing a risk of thermal runaway, including a metal housing 1 and a battery cell 2 filled in the housing.

The housing 1 includes an inner cylinder 101 and an outer cylinder 102, both of which are a cylindrical structure with a bottom and without a cover, herein the outer cylinder 102 includes an outer wall 1022 and a secondary outer wall 1021, an end face of the outer cylinder 102 is ring-shaped, the inner cylinder 101 is located in a through hole in the center of the outer cylinder 102, there is a gap 3 between a side wall of the inner cylinder 101 and the secondary outer wall 1021 of the outer cylinder, and a metal connecting rib 4 is arranged in the gap 3 to fixedly connect the inner cylinder 101 and the outer cylinder 102 as a whole and conduct through the metal connecting rib 4.

The battery cell 2 includes an outer battery cell 202 and an inner battery cell 201, the outer battery cell 202 is filled in a ring-shaped cavity of the outer cylinder 102, and the inner battery cell 201 is filled in a cavity of the inner cylinder 101; a lower end of the outer battery cell 202 is connected with a bottom plate of the outer cylinder 102 through an outer battery cell lower pole piece 802 to conduct; an upper end opening of the outer cylinder 102 is provided with a first battery protection assembly 602, and an upper end of the outer battery cell 202 is connected with an outer battery cell electrode cap 502 arranged on an upper surface of the first battery protection assembly 602 through an outer battery cell upper pole piece 702 to conduct, and the outer battery cell electrode cap 502 is ring-shaped; a lower end of the inner battery cell 201 is connected with a bottom plate of the inner cylinder 101 through an inner battery cell lower pole piece 801 to conduct; and an upper end opening of the inner cylinder 101 is provided with a second battery protection assembly 601, and an upper end of the inner battery cell 201 is connected with an inner battery cell electrode cap 501 arranged on an upper surface of the second battery protection assembly 601 through an inner battery cell upper pole piece 701 to conduct. The first battery protection assembly and the second battery protection assembly are not connected, and are two independent insulating assemblies.

In this application, by designing the housing of the lithium ion battery as an inner and outer nested structure, there is a gap between the inner cylinder and the outer cylinder, but the two are connected by the metal connecting rib integrally formed with the housing, and they are still essentially a whole. The outer battery cell and the inner battery cell are conducted through the metal housing. By changing the connection type of the positive and negative electrodes of the outer battery cell and the inner battery cell with the housing, the two battery cells may achieve the series connection or parallel connection.

This inner and outer nested structure may further increase the geometric size of a single lithium ion battery, so that the overall energy density of the battery pack is increased. Although the interior of this nested lithium ion battery is divided into two battery cells, the outer battery cell and the inner battery cell are connected through the housing to conduct, without the need for other external assemblies to connect. This structure is convenient for the connection of the outer battery cell and the inner battery cell on the one hand, and makes the working state of the outer battery cell and the inner battery cell in a separable and combinable state on the other hand, so options while the battery pack is assembled are increased.

The battery cell of the lithium ion battery related in the present invention is an ordinary winding battery cell, and the structure of the battery protection assembly is similar to the structure of a safety protection device of an ordinary cylindrical lithium ion battery, except that the shape is changed according to the need for the nested battery related in the present invention.

In this embodiment, the inner cylinder 101, the outer cylinder 102 and the connecting rib 4 are integrally formed, the structural stability is good.

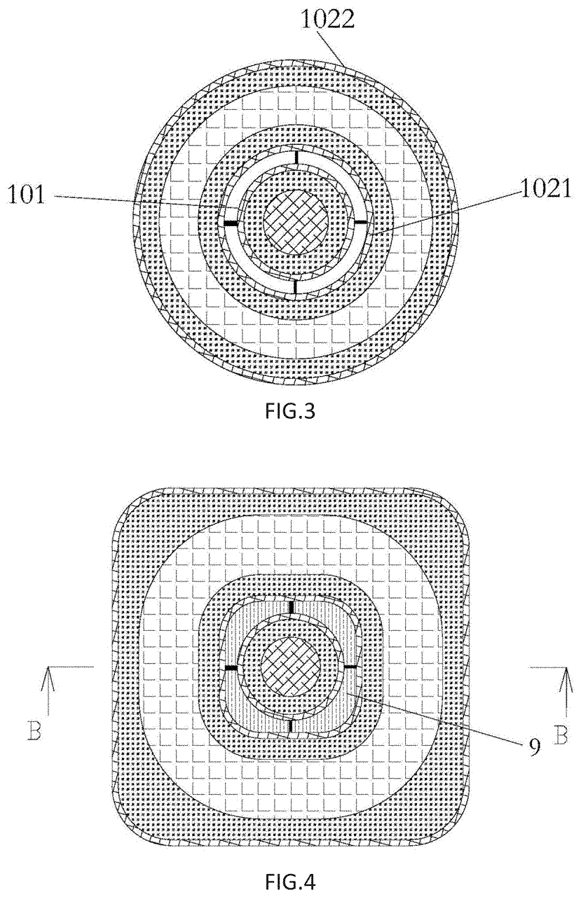

In this embodiment, the outer cylinder is cubic, and edges are rounded. As shown in FIG. 1, the inner cylinder is cylindrical, namely the end face is a circular ring. In other embodiments, the outer cylinder and the inner cylinder are both cylindrical, as shown in FIG. 3.

In this embodiment, the electrodes of the outer battery cell upper pole piece 702 and the inner battery cell upper pole piece 701 are the same, and both are the positive electrodes; and the inner battery cell lower pole piece 801 and the outer battery cell lower pole piece 802 are conducted with the housing, and both are the negative electrodes, the outer battery cell and the inner battery cell are connected in parallel through the housing. In other embodiments, the electrodes of the outer battery cell upper pole piece and the inner battery cell upper pole piece are the same, and may be the negative electrodes at the same time; and the lower pole piece of the inner battery cell and the lower pole piece of the outer battery cell are conducted with the housing, and both are the positive electrodes.

After the outer battery cell and the inner battery cell are connected to a circuit in parallel through the housing, there are three working states as follows:

1) while two wiring terminals in the circuit are respectively connected with the housing and the inner battery cell electrode cap to conduct, the inner battery cell is in the working state, and the outer battery cell does not work;

2) while the two wiring terminals in the circuit are respectively connected with the housing and the outer battery cell electrode cap to conduct, the outer battery cell is in the working state, and the inner battery cell does not work; and

3) while one wiring terminal in the circuit is connected with the inner battery cell electrode cap and the outer battery cell electrode cap to conduct at the same time, and the other wiring terminal is connected with the battery housing to conduct, the outer battery cell and the inner battery cell work simultaneously after being connected in parallel.

In other embodiments, the electrodes of the outer battery cell upper pole piece 702 and the inner battery cell upper pole piece 701 are different, the outer battery cell upper pole piece is the positive electrode, the inner battery cell upper pole piece is the negative electrode, the inner battery cell lower pole piece is the positive electrode, and the outer battery cell lower pole piece is the negative electrode, so the outer battery cell and the inner battery cell achieve the series connection through the battery housing, the inner battery cell electrode cap is the negative electrode of the battery, and the outer battery cell electrode cap is the positive electrode of the battery.

Alternatively, the electrodes of the outer battery cell upper pole piece and the inner battery cell upper pole piece are different, the outer battery cell upper pole piece is the negative electrode, the inner battery cell upper pole piece is the positive electrode, the inner battery cell lower pole piece is the negative electrode, and the outer battery cell lower pole piece is the positive electrode, so the outer battery cell and the inner battery cell achieve the series connection through the battery housing, the inner battery cell electrode cap is the positive electrode of the battery, and the outer battery cell electrode cap is the negative electrode of the battery.

After the outer battery cell and the inner battery cell are connected to a circuit in parallel through the housing, there are three working states as follows:

1) while two wiring terminals in the circuit are respectively connected with the housing and the inner battery cell electrode cap to conduct, the inner battery cell is in the working state, and the outer battery cell does not work;

2) while the two wiring terminals in the circuit are respectively connected with the housing and the outer battery cell electrode cap to conduct, the outer battery cell is in the working state, and the inner battery cell does not work; and

3) while the two wiring terminals in the circuit are respectively connected with the inner battery cell electrode cap and the outer battery cell electrode cap to conduct, the outer battery cell and the inner battery cell work simultaneously after being connected in series.

Therefore, while the nested battery described in this application is used for grouping, different voltages and a plurality of charging-discharging strategies may be achieved under the same connection scheme by selecting the lithium ion batteries of different assembly forms, and the intermittent operation of the outer battery cell and the inner battery cell may be achieved, so the continuous working temperature of the overall battery pack is reduced.

Since there is the gap 3 between the outer battery cell and the inner battery cell of the battery, the gap may serve as an air-cooled heat-dissipating air duct, so that the heat generated during the charging-discharging of the battery cell may be taken away by the air flowing through this gap. In addition to serving as the air duct, this gap also plays a role in reducing the thickness of the battery cell, so the thicknesses of the inner and outer battery cells are not too high, so that the heat may be transferred to the battery housing in time and be taken away by a heat-dissipating system, but the size of the battery may be made larger.

In the nested battery related to the present invention, since the battery is divided into two battery cells, and there is the gap 3 between the two parts, after the battery is subjected to an external mechanical acting force, there is a crumple space inside the battery, which may offset the external mechanical damage through deformation, and protect the safety of the overall battery pack.

### Embodiment II

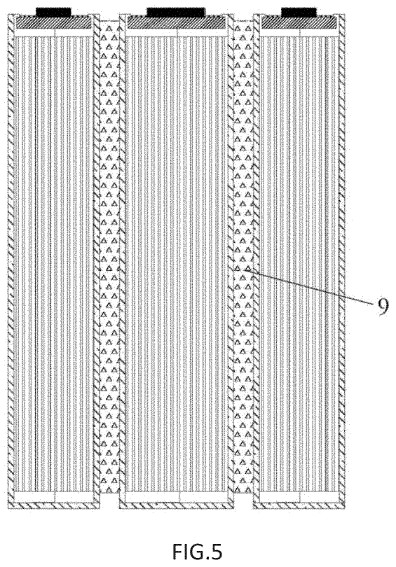

In this embodiment, as shown in FIGS. 4 and 5, the gap 3 between the side wall of the inner cylinder and the secondary outer wall of the outer cylinder is filled with a heat conduction material 9. The purpose of filling the heat conduction material 9 is to make the heat between the outer battery cell and the inner battery cell conduct, this type of the battery is not suitable for assembling in the battery pack that often works in the high temperature environment, but it is very suitable for assembling in the battery pack that often works in the low temperature environment.

In the low temperature environment, while the battery is enabled, the temperature is too low, it is easy to cause the significant decrease in battery performance, and it is easy to shorten the battery life and reduce the battery stability and safety in the long run. Therefore, in the low temperature environment, the using strategy of this nested battery is different from that of an ordinary lithium ion battery. While it is just enabled, only the inner battery cell 201 is used for work, so that a working current per unit volume of the battery cell is relatively large, and the inner battery cell generates the heat apparently. Since the inner battery cell 201 is wrapped by the heat conduction material 9, most of the heat generated is transferred to the outer battery cell 201 through the heat conduction material 9, and the outer battery cell 202 is heated. After the temperature of the outer battery cell 202 rises to a normal working temperature, the outer battery cell 202 is used for work, and the work of the inner battery cell 201 is temporarily stopped, or the two battery cells work at the same time, so that the temperature of the battery may be adjusted in a variety of ways. This type of the nested battery has the high heat use efficiency, and may heat the battery pack without the need for an additional heating device.

The other parts are the same as in Embodiment I.

It should be understood that the specific embodiments described here are only used to explain the present invention, but not to limit the present invention; and any modifications, equivalent replacements, improvements and the like made within the spirit and principle of the present invention shall be included in a scope of protection of the present invention.

1. A nested structure lithium ion battery capable of reducing a risk of thermal runaway, wherein the nested structure lithium ion battery comprises a metal housing and a battery cell filled in the housing;
the housing comprises an inner cylinder and an outer cylinder, both of which are a cylindrical structure with a bottom and without a cover, wherein the outer cylinder comprises an outer wall and a secondary outer wall, an end face of the outer cylinder is ring-shaped, the inner cylinder is located in a through hole in the center of the outer cylinder, there is a gap between a side wall of the inner cylinder and the secondary outer wall of the outer cylinder, and a metal connecting rib is arranged in the gap to fixedly connect the inner cylinder and the outer cylinder as a whole and conduct;
the battery cell comprises an outer battery cell and an inner battery cell, the outer battery cell is filled in a cavity of the outer cylinder, and the inner battery cell is filled in a cavity of the inner cylinder; a lower end of the outer battery cell is connected with a bottom plate of the outer cylinder through an outer battery cell lower pole piece to conduct; an upper end opening of the outer cylinder is provided with a first battery protection assembly, and an upper end of the outer battery cell is connected with an outer battery cell electrode cap arranged on an upper surface of the first battery protection assembly through an outer battery cell upper pole piece to conduct; a lower end of the inner battery cell is connected with a bottom plate of the inner cylinder through an inner battery cell lower pole piece to conduct; and an upper end opening of the inner cylinder is provided with a second battery protection assembly, and an upper end of the inner battery cell is connected with an inner battery cell electrode cap arranged on an upper surface of the second battery protection assembly through an inner battery cell upper pole piece to conduct.

2. The nested structure lithium ion battery capable of reducing the risk of thermal runaway according to claim 1, wherein the inner cylinder, the outer cylinder and the connecting rib are integrally formed.

3. The nested structure lithium ion battery capable of reducing the risk of thermal runaway according to claim 1, wherein the outer cylinder is a cylindrical or cubic housing.

4. The nested structure lithium ion battery capable of reducing the risk of thermal runaway according to claim 3, wherein the electrode polarities of the outer battery cell upper pole piece and the inner battery cell upper pole piece are the same, and the outer battery cell and the inner battery cell are connected in parallel through the housing.

5. The nested structure lithium ion battery capable of reducing the risk of thermal runaway according to claim 4, wherein after the outer battery cell and the inner battery cell are connected to a circuit in parallel through the housing, there are three working states as follows:
1) while two wiring terminals in the circuit are respectively connected with the housing and the inner battery cell electrode cap to conduct, the inner battery cell is in the working state, and the outer battery cell does not work;
2) while the two wiring terminals in the circuit are respectively connected with the housing and the outer battery cell electrode cap to conduct, the outer battery cell is in the working state, and the inner battery cell does not work; and
3) while one wiring terminal in the circuit is connected with the inner battery cell electrode cap and the outer battery cell electrode cap to conduct at the same time, and the other wiring terminal is connected with the battery housing to conduct, the outer battery cell and the inner battery cell work simultaneously after being connected in parallel.

6. The nested structure lithium ion battery capable of reducing the risk of thermal runaway according to claim 3, wherein the electrodes of the outer battery cell upper pole piece and the inner battery cell upper pole piece are different, and the outer battery cell and the inner battery cell are connected in series through the housing.

7. The nested structure lithium ion battery capable of reducing the risk of thermal runaway according to claim 6, wherein after the outer battery cell and the inner battery cell are connected to a circuit in series through the housing, there are three working states as follows:
1) while two wiring terminals in the circuit are respectively connected with the housing and the inner battery cell electrode cap to conduct, the inner battery cell is in the working state, and the outer battery cell does not work;
2) while the two wiring terminals in the circuit are respectively connected with the housing and the outer battery cell electrode cap to conduct, the outer battery cell is in the working state, and the inner battery cell does not work; and
3) while the two wiring terminals in the circuit are respectively connected with the inner battery cell electrode cap and the outer battery cell electrode cap to conduct, the outer battery cell and the inner battery cell work simultaneously after being connected in series.

8. The nested structure lithium ion battery capable of reducing the risk of thermal runaway according to claim 1, wherein the gap between the side wall of the inner cylinder and the secondary outer wall of the outer cylinder is filled with a heat conduction material.
